(19) United States
(12) Patent Application Publication
(10) Pub. No.: US 2025/0134129 A1
(43) Pub. Date: May 1, 2025

(54) NON-DAIRY PLANT ONLY FOOD PRODUCT

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/835,361

(22) PCT Filed: Feb. 4, 2023
(86) PCT No.: PCT/IB2023/051005

§ 371 Date: Aug. 9, 2024

(30) Foreign Application Priority Data
Feb. 10, 2022 (US) 63/308567
Feb. 4, 2023 (WO) PCT/IB2023/051005

(51) Int. Cl. A23G 9/42; A23G 9/32; A23G 9/34

(52) U.S. Cl. CPC A23G 9/42; A23G 9/327; A23G 9/34

(57) ABSTRACT

A plant-only food composition and methods of preparing the composition is provided. The food composition is free from dairy and other animal-based ingredients and has a desirable flavor, color, taste, texture, homogeneity and appearance to be aesthetically pleasing before consumption. The plant-only food composition includes a) 3.0-3.5% by weight of a protein,
b) 1.5-2.0% by weight of a fiber, c) 2.0-3.0% by weight of a cream, d) 0.1-0.2% by weight of a starch, e) 4-5.5% by weight of a fat, f) 21-27% by weight of a sweetener, g) 2-5% by weight of an anti-freezing agent, and h) 0.2-0.5% by weight of an anti-caking agent, i) 1-10% by weight of an emulsifier-stabilizer system, j) 0.5-1.0% by weight of a thickener, k) 2-3% by weight of a flavoring agent, and l) 40.0-55.0% by weight of water.

### PRIORITY PARAGRAPH

This application claims priority to the U.S. provisional patent application No. 63/308,567, filed on Feb. 10, 2022 and PCT provisional patent application no.: PCT/IB2023/051005, filed on Feb. 4, 2023, titled “NON-DAIRY PLANT ONLY FOOD PRODUCT” and is incorporated herein by reference.

### TECHNICAL FIELD

The disclosed embodiments relate generally to food compositions and, more particularly, to a dessert-type-only food composition with sensory characteristics similar to conventional diary-based frozen dessert products.

### BACKGROUND

Many conventional food products and, in particular, food dessert products (e.g., ice cream, sherbet, frozen yogurt, etc.) contain natural or synthetic food additives to serve as stabilizers, preservatives, sweeteners, and emulsifiers (e.g., for dairy products) in order to provide desired flavors, sweetening, textures, appearance, consistency and/or uniform blending or homogeneity to the food product when several different components or ingredients are combined to form the food product. Some examples of food additive sweeteners include acesulfame potassium, high fructose corn syrup, polysorbate 60/80, sucralose, and dextrose. Other example forms of food additives include silicon dioxide, sodium benzoate, sodium nitrite, artificial food color dyes, etc. Many such additives (particularly synthetic additives) can be harmful to people if consumed over prolonged periods.

In addition, many dessert products and, in particular, frozen dessert products (e.g., ice cream, sherbet, frozen yogurt, etc.) tend to contain dairy and/or egg ingredients which can be undesirable for some people (e.g., to some who are lactose intolerant or have a milk or dairy allergy). For people interested in a vegetarian or plant-only diet, this limits the variety of available dessert products on the market.

It would be desirable to provide a non-dairy dessert or other non-dairy food product that is plant-only and minimizes or avoids the use of additives outside of the plant genus while ensuring desirable flavor, texture, appearance, and taste.

### SUMMARY

A plant-based or plant-only food composition that is free from diary and other animal-based ingredients that has desirable flavor, taste, color, texture, appearance, homogencity, and consistency to be aesthetically pleasing before consumption is provided. In particular, the plant-only food product includes entirely 100% of components or ingredients from the plant genus (i.e., photosynthetic eukaryotes from the kingdom Plantae), and further excludes any component or ingredient that is dairy-based, that is from the animal genus (including animal fats and animal proteins) and also excludes any synthetically derived component or ingredient. The plant-only ingredients of the food composition replace conventional animal-based ingredients, including milk, cream, and eggs, as well as conventional chemical-based additives such as gums, stabilizers, emulsifiers, preservatives, anti-freezing, anti-caking agents, binders, etc. The product formed solely from plant-only food composition is further free from gluten, soy, cholesterol, and trans fatty acids.

According to an aspect of the present invention, a plant-only food composition is provided. The composition comprises a) 3.0-3.5% by weight of a protein, b) 1.5-2.0% by weight of a fiber, c) 2.0-3.0% by weight of a cream, d) 0.1-0.2% by weight of a starch, c) 5.4% by weight of a fat, f) 21-27% by weight of a sweetener, g) 2-5% by weight of an anti-freezing agent, and h) 0.2-0.5% by weight of an anti-caking agent, i) 1-10% by weight of an emulsifier-stabilizer system, j) 0.5-1.0% by weight of a thickener, k) 2-3% by weight of a flavoring agent, and l) 40.0-55.0% by weight of water.

According to an embodiment, the protein is selected from pea protein, soy protein, potato protein, chickpea, quinoa, black lentil, peanut, almond, chia seeds, pinto beans, oats, melon seeds, or combinations thereof.

According to another embodiment, the fiber is selected from corn fiber, black lentil, citrus fiber, balangu seed fiber, psyllium fiber, quince seed flour, oat fiber, wheat germ, artichoke fiber, pea fiber, chicory root fiber, cranberry, mangosteen, sapodilla-walnut, white peach, rice crisps or combinations thereof.

According to yet another embodiment, the cream is selected from coconut cream, rice cream, cashew cream, sesame seeds cream, cassava cream, oat milk cream, white bean cream, tofu cream, three-leaf yam cream, or combinations thereof.

According to yet another embodiment, the starch is selected from tapioca starch, jackfruit seed starch, taro starch, yam starch, arrowroot starch, potato starch, rice starch, cassava starch, wheat starch, sweet potato starch, wheat starch, or combinations thereof.

According to yet another embodiment, the fat is selected from sunflower oil, olive oil, mango kernel fat, peanut oil, palm kernel oil, soybean oil, safflower oil, cocoa butter, corn oil, flaxseed oil, sesame oil, or combinations thereof.

According to yet another embodiment, the sweetener is a plant-derived sugar selected from allulose (figs), banana, custard apple, raisins, durian, pears, prunes, monk fruit, sapodilla, agave, dried apricots, date palm, mangosteen, barhi dates or combinations thereof.

According to yet another embodiment, the anti-freezing agent is selected from oats, psyllium seed gum, quince seed gum, dragon fruit (pulp polysaccharides), avocado fruit, corn fiber, sugar beet, sunflower oil, custard apple fruit, chia seed mucilage polysaccharides, tamarillo or combinations thereof.

According to yet another embodiment, the anti-caking agent is selected from sunflower oil, avocado fruit, coconut cream, sugar beet, dragon fruit (pulp fiber), jackfruit, rice hulls, arrowroot flour, citrus fiber, potato starch or combinations thereof.

According to yet another embodiment, the emulsifier of the emulsifier-stabilizer system is selected from avocado, flaxseed mucilage, dragon fruit (peel), lentil, faba bean, oat bran extract, durian rind, liquorice root, chia seeds mucilage, pea protein or combinations thereof.

According to yet another embodiment, the stabilizer of the emulsifier-stabilizer system is selected from psyllium seed gum, okra gum, gundelia, basil seed gum, balangu seed, banana fruit, corn fiber, flax seed mucilage, baobab fruit, aloe vera or combinations thereof.

According to yet another embodiment, the thickener is selected from quince seed gum, thale cress, Ipomoea digitata seed, banana fruit, corn fiber, flax seed mucilage, baobab fruit, aloe vera, Thai hoary basil seed, kudzu flour, arrowroot (flour) or combinations thereof.

According to yet another embodiment, the flavoring agent is selected from blackberry, choco chips, choco almonds, blueberries, raspberries, strawberries, mango & passion fruit, ginger, custard apple, nutmeg, cinnamon, clove, cardamom, star anise, orange.

According to yet another embodiment, the plant-only food composition is a frozen dessert product.

According to another aspect of the present invention, a plant-only food composition is provided. The composition includes a) 3.0-3.5% by weight of a protein, b) 1.5-2.0% by weight of a fiber, c) 2.0-3.0% by weight of a cream, d) 0.1-0.2% by weight of a starch, c) about 5.4% by weight of sunflower oil, f) 21-27% by weight of a sweetener, g) 2-5% by weight of sugar beet, and h) 0.2-0.5% by weight of avocado fruit, i) 0.2-0.5% by weight of banana fruit, j) 5-10% by weight of Flax seed mucilage, k) 2-3% by weight of Custard apple, l) 0.5-1.0% by weight of Baobab fruit, m) 0.2-0.5% by weight of Aloe vera, and n) 40.0-55.0% by weight of water.

According to an embodiment, the protein is selected from pea protein, soy protein, potato protein, chickpea, quinoa, black lentil, peanut, almond, chia seeds, pinto beans, oats, melon seeds, or similar/combinations thereof.

According to another embodiment, the fiber is selected from corn fiber, black lentil, citrus fiber, balangu seed fiber, psyllium fiber, quince seed flour, oat fiber, wheat germ, artichoke fiber, pea fiber, chicory root fiber, or similar/combinations thereof.

According to yet another embodiment, the cream is selected from coconut cream, rice cream, cashew cream, sesame seeds cream, cassava cream, oat milk cream, white bean cream, tofu cream, three-leaf yam cream, or similar/combinations thereof.

According to yet another embodiment, the starch is selected from tapioca starch, jackfruit seed starch, taro starch, yam starch, arrowroot starch, potato starch, rice starch, cassava starch, wheat starch, sweet potato starch, wheat starch, or similar/combinations thereof.

According to yet another embodiment, the sweetener is a plant-derived sugar selected from allulose (figs), banana, custard apple, raisins, durian, pears, prunes, monk fruit, sapodilla, agave, dried apricots, date palm, mangosteen, barhi dates or similar/combinations thereof.

According to yet another embodiment, the avocado fruit, the banana fruit, the baobab fruit, the flaxseed mucilage, and the aloe vera form an emulsifier-stabilizer system.

According to yet another embodiment, a combination ratio of the avocado fruit and the banana fruit in the emulsifier-stabilizer system comprises a weight ratio from 60:40 to 40:60, preferably a weight ratio of 50:50.

According to yet another embodiment, a weight ratio of baobab fruit to aloe vera fruit in the emulsifier-stabilizer system comprises from 1.5:1 to 2.5:1.

According to yet another aspect of the present invention, a method of preparing a plant-only food composition is provided. The method includes (i) mixing a) 3.0-3.5% % by weight of a protein, b) 1.5-2.0% by weight of a fiber, c) 2.0-3.0% by weight of a cream, d) 0.1-0.2% by weight of a starch, e) 5.4% by weight of a sweetener, f) 0.5-1.0% by weight of a thickener, and g) 40.0-55.0% by weight of water at 18000 RPM in a blender to obtain a first mixture, (ii) cooking the first mixture at 90 degrees Celsius for about 10 to 12 minutes with occasional stirring, (iii) cooling the first mixture to 60 degrees Celsius and adding 2-3% by weight of a flavoring agent and blending at 18000 RPM using a blender, (iv) straining using a fine mesh strainer to obtain a second mixture, (v) adding 1-10% by weight of an emulsifier-stabilizer system, 5.4% by weight of a fat, 2-5% by weight of an anti-freezing agent, and 0.2-0.5% by weight of an anti-caking agent to the second mixture and mixing using a high shear homogenizer with a fine slotted stator at 8000 RPM at a pressure of 150 Bar for 15 minutes to obtain a third mixture, (vi) pasteurizing the third mixture at 73 to 75 degrees Celsius for about 15 minutes, (vii) cooling and aging the pasteurized third mixture for greater than 4 hours at less than or equal to 5 degrees Celsius to control ice crystallization to obtain a cooled and aged third mixture, (viii) batch freezing of the cooled and aged third mixture between −7 to −3 degrees Celsius for about 6 minutes to achieve an overrun of 12 to 20%, (xi) performing low-temperature freezing and kneading at −8 degrees Celsius to −15 degrees Celsius to obtain the plant-only food composition.

According to an embodiment, the method comprises, (i) blast freezing the plant-only food composition at −20 degrees Celsius, (ii) freezing for about 48 to 72 hours; (iii) storing the plant-only food composition at −25 degrees Celsius.

According to another embodiment, the protein is selected from pea protein, soy protein, potato protein, chickpea, quinoa, black lentil, peanut, almond, chia seeds, pinto beans, oats, melon seeds, or similar/combinations thereof.

According to yet another embodiment, the fiber is selected from corn fiber, black lentil, citrus fiber, balangu seed fiber, psyllium fiber, quince seed flour, oat fiber, wheat germ, artichoke fiber, Pea fiber, chicory root fiber, or similar/combinations thereof.

According to yet another embodiment, the cream is selected from Coconut cream, rice cream, cashew cream, sesame seeds cream, cassava cream, oat milk cream, white bean cream, tofu cream, three-leaf yam cream, or similar/combinations thereof.

According to yet another embodiment, the starch is selected from tapioca starch, jackfruit seed starch, taro starch, yam starch, arrowroot starch, potato starch, rice starch, cassava starch, wheat starch, sweet potato starch, wheat starch, or similar/combinations thereof.

According to yet another embodiment, the fat is selected from sunflower oil, olive oil, mango kernel fat, peanut oil, palm kernel oil, soybean oil, safflower oil, cocoa butter, corn oil, flaxseed oil, sesame oil, or similar/combinations thereof.

According to yet another embodiment, the sweetener is a plant-derived sugar selected from allulose (figs), banana, custard apple, raisins, durian, pears, prunes, monk fruit, sapodilla, agave, dried apricots, date palm, mangosteen, barhi dates or similar/combinations thereof.

According to yet another embodiment, the anti-freezing agent is selected from oats, psyllium seed gum, quince seed gum, dragon fruit (pulp polysaccharides), avocado fruit, corn fiber, sugar beet, sunflower oil, custard apple fruit, chia seed mucilage polysaccharides, tamarillo or similar/combinations thereof.

According to yet another embodiment, the anti-caking agent is selected from sunflower oil, avocado fruit, coconut cream, sugar beet, dragon fruit (pulp fiber), jackfruit, rice hulls, arrowroot flour, citrus fiber, potato starch or similar/combinations thereof.

According to yet another embodiment, the emulsifier of the emulsifier-stabilizer system is selected from avocado, flaxseed mucilage, dragon fruit (peel), lentil, faba bean, oat bran extract, durian rind, liquorice root, chia seeds mucilage, pea protein or similar/combinations thereof.

According to yet another embodiment, the stabilizer of the emulsifier-stabilizer system is selected from psyllium seed gum, okra gum, gundelia, basil seed gum, balangu seed, banana fruit, corn fiber, flax seed mucilage, baobab fruit, aloe vera or similar/combinations thereof.

According to yet another embodiment, the thickener is selected from quince seed gum, thale cress, Ipomoea digitata seed, banana fruit, corn fiber, flax seed mucilage, baobab fruit, aloe vera, Thai hoary basil seed, kudzu flour, arrowroot (flour) or similar/combinations thereof.

According to yet another embodiment, the flavoring agent is selected from blackberry, choco chips, choco almonds, blueberries, raspberries, strawberries, mango & passion fruit, ginger-custard apple, nutmeg, cinnamon, clove, cardamom, star anise, orange.

According to yet another embodiment, physical characterization data associated with the ingredients of the plant-only food composition comprising the protein, the fiber, the cream, the starch, the sweetener, the thickener, the emulsifier, the stabilizer, the fat, the anti-freezing agent, the anti-caking agent is stored in a database. A machine learning model determines a unique combination of ingredients based on the physical characterization data to prepare the plant-only food composition.

According to yet another embodiment, the physical characterization data of the ingredients comprise functional properties that comprise emulsification properties, stabilization properties, gelling properties, fat-replacement properties, ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

According to yet another embodiment, the plant-only food composition is a frozen dessert product.

Several aspects of the invention are described below with reference to examples for illustration. However, one skilled in the relevant art will recognize that the invention can be practiced without one or more of the specific details or with other methods, components, materials, and so forth. In other instances, well-known structures, materials, or operations are not shown in detail to avoid obscuring the features of the invention. Furthermore, the features/aspects described can be practiced in various combinations, though only some of the combinations are described herein for conciseness.

### BRIEF DESCRIPTION OF THE DRAWINGS

Example embodiments of the present invention will be described with reference to the accompanying drawings briefly described below.

FIGS. 1A-B illustrate a flow chart of a method of preparing a plant-only food composition according to the aspect of the present disclosed embodiments.

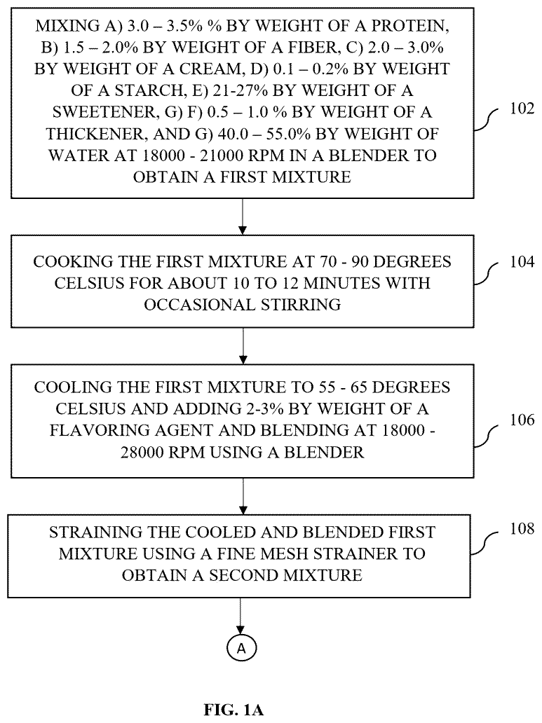

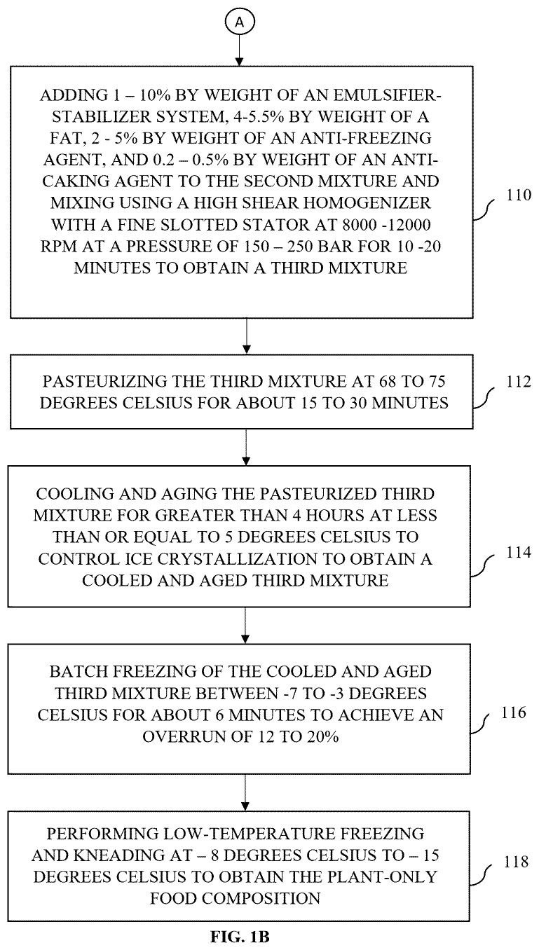

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE DISCLOSED EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another. Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, i.e., edible compounds sourced from plants, fungi or algae that comprises one or more naturally occurring chemical compounds.

As used herein, the singular forms “a”, “an”, and “the” include both singular and plural referents unless the context clearly dictates otherwise. By way of example, “a dosage” refers to one or more than one dosage.

The terms “comprising”, “comprises” and “comprised of” as used herein are synonymous with “including”, “includes” or “containing”, “contains”, and are inclusive or open-ended and do not exclude additional, non-recited members, elements or method steps.

All documents cited in the present specification are hereby incorporated by reference in their totality. In particular, the teachings of all documents herein specifically referred to are incorporated by reference.

Example embodiments of the disclosed embodiments are described with reference to the accompanying figures.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily comprise a reference to the same embodiment. Finally, regardless of whether it is expressly described herein, one of ordinary skill in the art would readily appreciate that each of the particular features, structures, or characteristics of the given embodiments may be utilized in connection or combination with those of any other embodiment discussed herein.

In the drawings, like reference numbers generally indicate identical, functionally similar, and/or structurally similar elements. The drawing in which an element first appears is indicated by the leftmost digit(s) in the corresponding reference number.

### Definitions

“Protein” refers to macromolecules that comprise one or more long chains of amino acid residues.

“Fiber” refers to an indigestible carbohydrate.

“Cream” refers to a thick yellowish-white liquid.

“Starch” refers to a polymeric carbohydrate consisting of numerous glucose units.

“Fat” refers to any ester of fatty acids or a mixture of such compounds. “Derived sugars” refers to modified monosaccharides.

“anti-freezing agent” refers to an additive that when added to a water-based fluid reduces the freezing point of the mixture.

“anti-caking agent” refers to an additive to prevent the formation of lumps.

“Emulsifier” refers to an additive used to help mix two substances that typically separate when they are combined.

“Thickener” refers to a substance that increases the viscosity of a liquid without substantially changing its other properties.

“Stabilizer” refers to an additive to food that helps to preserve its structure.

“Flavoring agent” refers to an additive that provides an additional taste or flavor. “Pasteurization” refers to the partial sterilization of a product to make it safe for consumption and improve its keeping quality.

Centrifuging: Centrifuging is a process that uses centrifuging force for the separation of two liquids in a mixture.

“Batch freezing” refers to freezing and whipping simultaneously to obtain a smooth consistency of a product.

“Kneading” refers to pressing for obtaining a smooth product.

“Machine learning model” refers to computer software designed to recognize patterns or behaviors based on previous experience or data.

“Clean label” refers to food products containing natural, familiar, simple ingredients with no artificial ingredients or synthetic chemicals.

“Plant-derived” refers to ingredients extracted from a plant.

“Plant-only” products disclosed herein, as opposed to products labeled as apart from any significant amount of water added, are derived solely from sources outside of the animal kingdom, e.g., from plants, fungi, or algae. That is, “plant-only” ma refer to any agent, ingredient, or component of a food product, or the entire food product itself, that is produced, developed, or otherwise obtained directly or indirectly from one or more plants, fungi, or algae, is not synthetic, and is only minimally processed for production, e.g., cleaned, dried, pulverized, etc.

The term “food product” refers broadly to any edible good or product, raw or cooked, savory or sweet, whether intended for human or animal consumption; a food product may be edible although not intended to be consumed on its own but, rather, incorporated into a second (or third) food product that is considered a consumable. In certain embodiments, while some of the water content of a food product may be derived from a plant source, water may also be added to the product from an external source. For example, in scenarios in which a plant only agent or system or plant only food product is in the form of a gel or liquid, it is further understood that water can be included as solvent or liquid carrier for the plant-only system, ingredient or food product, where any amount of water (some or all) within the system, ingredient or food product may or may not be derived from a plant source.

In the disclosed embodiments, apart from externally-sourced water, the plant-derived food product consists entirely of ingredients derived from plants, fungi or algae, excluding any component or ingredient that is: (i) dairy-based or otherwise derived from any member of the animal kingdom; and (ii) more than minimally processed; and (ii) synthetic.

### Method of Preparing the Plant-Only Food Composition

The method of preparing the plant-only food composition according to the disclosed embodiments provides a plant-based or a plant-only food composition that is free from dairy and other animal-based ingredients that has desirable flavor, taste, color, texture, appearance, homogencity, and consistency to be aesthetically pleasing before consumption. At step 102, a) 3.0-3.5% by weight of a protein, b) 1.5-2.0% by weight of a fiber, c) 2.0-3.0% by weight of a cream, d) 0.1-0.2% by weight of a starch, c) 21-27% by weight of a sweetener, g) f) 0.5-1.0% by weight of a thickener, and g) 40.0-55.0% by weight of water are mixed at 18000-21000 RPM in a blender to obtain a first mixture. At step 104, the first mixture is cooked at 70-90 degrees Celsius for about 10 to 12 minutes with occasional stirring. At step 106, the first mixture is cooled to 55-65 degrees Celsius, and 2-3% by weight of a flavoring agent is added and blended at 18000-28000 RPM using a blender. At step 108, the cooled and blended first mixture is strained using a fine mesh strainer to obtain a second mixture. At step 110, 1-10% by weight of an emulsifier-stabilizer system, 4-5.5% by weight of a fat, 2-5% by weight of an anti-freezing agent, and 0.2-0.5% by weight of an anti-caking agent is added to the second mixture and mixed using a high shear homogenizer with a fine slotted stator at 8000-12000 RPM at a pressure of 150-250 Bar for 10-20 minutes to obtain a third mixture. At step 112, the third mixture is pasteurized at 68 to 75 degrees Celsius for about 15 to 30 minutes. At step 114, the pasteurized third mixture is cooled and aged for greater than 4 hours at less than or equal to 5 degrees Celsius to control ice crystallization to obtain a cooled and aged third mixture. At step 116, the cooled and aged third mixture is batch frozen between −7 to −3 degrees Celsius for about 6 minutes to achieve an overrun of 12 to 20%. At step 118, low-temperature freezing and kneading are performed at −8 degrees Celsius to −15 degrees Celsius to obtain the plant-only food composition.

Selection of specific plant-only ingredients, or specific combinations of plant only or plant derived ingredients, provide effective functionalities such as emulsifiers, stabilizers, texturizing and thickening, fat replacement, sugars or other sweeteners, antifreezing properties, anti-caking properties, etc. for the food composition without the need to add such conventional, non-plant-only additives. As used herein, the term “component” or “ingredient” refers to a particular item that includes one or more chemical compounds (e.g., a food item from the plant species that comprises one or more naturally occurring chemical compounds). The term “plant-only”, as used herein, refers to a product or formulation (e.g., food product or food formulation) that is 100% derived from ingredients from that plant genus.

The plant-only protein is obtained from different legumes as per their availability. The protein isolation and concentration are done by solubilization and precipitation/filtration to separate from the carbohydrate part. The protein is isolated using clean label methods with minimum or no use of chemicals. The isolated proteins have good functionality.

The plant-only fiber is extracted with the use of clean label methods and with minimum use of chemicals. If the plant-only fiber is procured from the suppliers, the process and purity are tracked.

Plant-only cream is made by mixing the peeled, shredded nut or seed ingredient with water and performing homogenization. The water layer is discarded and the creamy layer is retained. To make it to desired consistency/viscosity, an emulsifier stabilizer system is used as per the application.

Plant-only starch is prepared by solubilizing the fiber and protein part and separated from starch using filtration/centrifugation.

Plant-only fat is procured from the suppliers keeping the track of their process and purity. Plant derived sugars/sugar derivatives are procured from the suppliers keeping the track of their process and purity.

Fruit and vegetable pulps are obtained by cleaning, peeling, deseeding and

homogenizing fresh fruits or vegetables to desired consistency with or without the addition of water.

Seed/husk mucilage is prepared by boiling seeds/husk with water in a specific ratio (1:15, 1:20, 1:25) for a specific time range depending upon the use. Later, the mucilage part is filtered out and kept ready for use.

Aloe Vera mucilage is prepared by peeling the Aloe Vera. Later the pulp is mixed/homogenized to desired consistency.

### Functionality and Parameters

TABLE 1
Parameter ranges associated with ingredients of the plant-only food composition.

| Functionality | Parameters | | | |
|---|---|---|---|---|
| Plant-only | Zeta potential −20 | Solubility | Isoelectric | Foaming |
| protein | to −40 mV | index | pH: 4 to 5 | capacity: |
| | | 20-16% | | 38-120% |
| | | and | | or more |
| | | Molecular | | |
| | | weight: | | |
| | | 10-50 kDa | | |
| Plant-only | Water | Swelling | Freezing | |
| fiber | absorption/ | power: | point | |
| | retention capacity | 20.76-26.92% | depression −3 | |
| | (WAC): 4-25 g/g | | to −5 C. | |
| Plant-only | Fat percentage: | pH: | Total | Emulsion |
| cream | 16-50% | 4.5-6 | solids: | stability |
| | | | 25.4-37.3 | 50-96% |
| Plant-only | Pasting | Peak/ | WAC/WHC: | Swelling |
| starch | Temperature: | Maximum | 415.13-595.26% | power/ |
| | 68.6-69.3° C. | viscosity | | Hydration |
| | | (BU) | | capacity: |
| | | 0.1 and | | 20.76-26.92% |
| | | 0.9 Pa · s, | | Amylose |
| | | at a shear | | content: |
| | | rate of | | 15-30% |
| | | 115 s−1 | | |
| Plant-only | HLB score: | Emulsion | Fat | Freezing |
| fat | Veg. oils should | stability: | content: >16% | point >−25 |
| | have 6 | 30-70% | | degree |
| | (required) | | | C. (taken |
| | | | | from the |
| | | | | backfill |
| | | | | sheet) |
| | | | | could not |
| | | | | find much |
| | | | | info on it. |
| Plant derived | Type of | Glycemic | Relative | Viscosity |
| sweeteners | carbohydrates/ | index | sweetness | Should be |
| | sweetener | Low GI: 1 | with | less |
| | response: high | to 55. | sucrose. | viscous. |
| | intensity, longer | Medium | | below 600 |
| | time. | GI: 56 to | | cP |
| | | 69 | | |
| Anti-freezing | Molecular | Type - | Water | Gelling/ |
| agent | weight: >300 | Anti- | binding | Viscosity ~3000 |
| | kDa | Freeze | ability: | mPa. S to |
| | Higher | Proteins | Hydrocolloids | 9000 mPa. |
| | preferred. | (AFPs) OR | & fiber: | S (can be |
| | | Hydrocolloids | 20-232 g/g | more than |
| | | OR fiber | AFP: | 9000) |
| | | | 2.83~3.35 | |
| | | | (g/g) | |
| Anti-caking | Foaming | Emulsion | Zeta | |
| agent | stability | stability | potential: −5 | |
| | 40-74.3% | 20% to | to −15 | |
| | | 84.03% | mV or | |
| | | | more | |
| Emulsifier | HLB value | Emulsion | Zeta | Emulsion |
| | 8 to 18 | capacity: | potential −15 | capacity |
| | | 20-70% | to −24.3 | depends on |
| | | or more | or more | pH. |
| | | | | pH: 3 to 6 |
| Thickener/ | Viscosity | WHC | Oil | |
| Texturiser | 6000 to 7500 | 35 to | Absorption | |
| | mPas (taken | 1024.66 | Capacity | |
| | w.r.t. Guar gum) | (g/g) | (OAC) | |
| | | | 114 to | |
| | | | 214.66 | |
| | | | or more | |
| | | | (g/g) | |
| Stabilizer | Emulsion | WHC | Emulsion | |
| | stability | 35 to | stability: | |
| | 60-99% | 1024.66 | 20% to | |
| | | (g | 90% | |
| | | water/100 | | |
| | | gm gum) | | |

The physical characterization data associated with the ingredients of the plant only food composition comprising the protein, fiber, cream, starch, sweetener, thickener, emulsifier-stabilizer system, fat, anti-freezing agent, and anti-caking agent is stored in a database. A machine learning model determines a unique combination of ingredients based on the physical characterization data to prepare the plant-only food composition. The machine learning model identifies plant-based ingredient replacements based on the parameters and ranges provided in Table 1 to give the list of ingredients for each possible functionality.

### EXAMPLE EMBODIMENTS

The disclosed embodiments are illustrated in further detail by the following non-limiting examples.

In example embodiments, the plant-only food composition includes a combination of components or ingredients from the plant genus that render the combinations in the amounts according to the disclosed embodiments particularly suitable as an emulsifier-stabilizer system that can be combined with other components or ingredients from the plant genus so as to form a specific form of a food product. Some examples of plant-only food products that incorporate the emulsifier-stabilizer system as described herein include plant-only frozen dessert products, such as plant-only ice cream, plant-only salad oils or salad dressings, and any other plant-only food products containing fatty acids, oils and/or other organic compounds that are insoluble and/or immiscible in aqueous-based formulations.

In other example embodiments, specific and unique combinations of plant-only ingredients are combined with the plant-only emulsifier-stabilizer system to form dessert products such as ice cream having properties very close in similarity with conventional (dairy-based) frozen dessert products.

The selection of a specific combination of ingredients for the plant-only food composition was determined using a proprietary machine learning platform that utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g. emulsification properties, stabilization properties, gelling properties, fat-replacement properties, etc.), Ayurvedic and/or other holistic properties, physicochemical properties (e.g. pH, viscosity, moisture content, density, etc), mechanical properties (e.g. adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc). Based upon the known properties of ingredients in the database, the desired properties for the food product or formulation, and one or more algorithms associated with the proprietary machine learning platform, a unique combination of plant-only components or ingredients was determined to yield an effective formulation that can be used as an emulsifier-stabilizer system for food based products, such as forming a desirable food product or formulation that is effective as a substitute for conventional dairy-based ice cream and other frozen dessert products.

### Example 1: Plant-Only Emulsifier-Stabilizer System

Emulsifiers comprise molecules that form around hydrophobic, water-insoluble organic molecules such as fat/lipid droplets in an aqueous medium to enable or enhance the homogenization of such water-insoluble compounds throughout a formulation. Highly effective emulsifiers have a hydrophilic-lipophilic balance (HLB) value from 818 and provide homogenous and finely dispersed oil-in-water emulsions. The selection of the specific combination of ingredients for the emulsifier-stabilizer system provides the system with an HLB value within this desired range, thus making it effective in facilitating fine dispersion of fat droplets and other water-insoluble plant-only molecules throughout a food product formulation.

An emulsifier-stabilizer system of the plant-only food composition comprises a combination of the plant-only components or ingredients from the plant genus and comprises the following essential ingredients: avocado fruit (e.g., in the form of a pulp or paste), banana fruit (e.g., in the form of a pulp or paste), baobab fruit (e.g., in the form of a pulp or paste), flax seed mucilage, and aloe vera (e.g., in the form of pulp or mucilage). The emulsifier-stabilizer system may also include lemon juice and/or lime juice to control color by preventing or minimizing oxidation of chemical compounds in the avocado fruit and the banana fruit as described herein.

Avocado fruit is provided in the emulsification and stabilizer system due to its rich content of oleic acid and other monounsaturated fatty acids (MUFAs), and its creamy texture and taste feel. The MUFAs in avocado fruit can function as natural surfactants that, when activated (e.g., when the avocado fruit is mashed or pulverized to form a pulp or fine paste), are highly effective for use in oil and water emulsions. Avocado fruit is a further nutrient and phytochemical dense, including fat-soluble vitamins such as vitamins A, D, K, and E. In particular, avocado fruits contain a high total fat content (about 15% by weight of the avocado fruit), a significant portion of which are MUFAs (about 9.8% by weight), a high phytosterol content (about 57 mg/100 g), and high in dietary fiber as well as including vitamins A, C, D, K, E and B complex and also minerals such as potassium and magnesium. The avocado pulp contains from 67 to 78% by weight (i.e., by weight of the pulp) moisture, 13.5 to 24% by weight lipids, 0.8 to 4.8% by weight carbohydrates, 1.0 to 3.0% by weight protein, 0.8 to 1.5% by weight ash, and 1.4 to 3.0% by weight fiber, and the avocado pulp further has an energy density between 140 and 228 kcal.

The avocado fruit further has a soft and mushy texture that renders it desirable for a variety of different food products. Avocado fruit used to form the emulsifier stabilizer system can be provided as pulp or a paste that is obtained by separating the flesh of the avocado from its skin and seed. The amount of avocado provided in the emulsifier-stabilizer system as well as any food product formed with the emulsifier stabilizer system affects the viscosity of the product, where an increase in the amount of avocado fruit in the product increases the fiber and also cause an increase in viscosity of the emulsifier-stabilizer system and product.

Banana fruit, with its firmness and cohesiveness (due, at least in part, to its pectin content), fibrous texture, and good resistance to temperature fluctuations, enhances the properties of the emulsifier-stabilizer system, particularly when combined with avocado fruit. For example, starches in banana fruit are relatively low in amylase content, have high resistance to heating and amylase attack, low swelling properties, and low retrogradation, which renders banana fruit in the food industry useful as a gelling agent, thickening agent, and stabilizer. The banana fruit (e.g., Cavendish banana fruit) is peeled to have its skin removed and can also be provided in a pulp, puree, or paste form. An effective combination ratio of avocado fruit and banana fruit in the emulsifier-stabilizer system was determined to be an avocado to banana weight ratio from 60:40 to 40:60, such as a 50:50 weight ratio (i.e., about the same amount of avocado fruit and banana fruit combined in the emulsifier-stabilizer system). This combination of avocado fruit with banana fruit provides a rich source of lipids, sugars, saponins, and phenolic acids for the emulsifier-stabilizer system.

Baobab fruit can also assist in emulsification by enhancing fat droplet formation (forming finer fat droplets) in an aqueous medium. Some of the main components of baobab fruit include polysaccharides, campesterol, and other steroids, flavonoids, epicatechin, tocopherol (Vitamin E), adansonin, and amino acids which serve as good antioxidants, emulsification enhancers, and stabilizers. The baobab fruit also has sour and sweet flavors that render it suitable for achieving a variety of different flavor profiles in food products. The skin of the baobab fruit can be removed and the fruit is mashed to a pulp or paste when combined with avocado fruit, banana fruit and other ingredients to form the emulsifier-stabilizer system.

Flax seed is rich in fiber, protein as well as fatty acids including Omega 3 and Omega 6 fatty acids, and also Alpha Linoleic acid. The flax seed, when processed to form a mucilage, adds an oily, sticky, and slimy texture that is similar to an egg product and further provides a flavor profile that is nutty, sweet, oily, and slightly bitter. Flax seed mucilage comprises soluble fiber in an amount of about 7-10% by weight of the flax seed mucilage, about 80% by weight neutral and acidic polysaccharides, and about 9% by weight protein. The neutral monosaccharides comprise xylose, glucose, arabinose, and galactose, while acidic monosaccharides comprise rhamnose, galactose, fructose, and galacturonic acid. Flax seed mucilage, when combined with the other ingredients for the emulsifier-stabilizer system, can provide thickening (increased viscosity), texturizing, and gelation characteristics for the emulsifier-stabilizer system as well as enhancing dispersion properties of fat droplets in a food product. The protein in the flax seed mucilage also enhances lipid emulsion for the emulsifier-stabilizer system by which a layer of protein is adsorbed at the surface of fat globules within a food product to which the emulsifier-stabilizer system is added.

An example embodiment of converting flax seeds into flax seed mucilage for use in the emulsifier-stabilizer system as described herein comprises washing flax seeds to remove surface dust and then stirring with distilled water for a suitable time and temperature and at a suitable speed in a mixer to form a mucilage. A specific example describing a method of forming mucilage from flaxseed is described by S. W. Cui, Polysaccharide gums from agricultural products: Processing, structures and functionality, Technomic Publishing Co., Inc., Lancaster PA (2001), the contents of which are incorporated herein by reference in its entirety. For example, the flax seeds can be stirred for about 5 hours in distilled water at about 60° C. and a mixing speed of about 300 rpm. The mucilage can be separated from the solution by filtering, e.g., through a 40-mesh screen, then precipitated with 95% ethanol, followed by further separation by centrifugation (e.g., at 3000 rpm for about 10 minutes). The precipitated flax seed mucilage can then be dried in a hot air oven at a temperature of about 60° C. It is noted that any other conventional method for forming flax seed mucilage from natural flax seeds can also be performed to obtain the flax seed mucilage.

Aloe vera is provided as a pulp or mucilage in the emulsifier-stabilizer system when released from the leaves of the aloe vera plant. The aloe vera pulp or mucilage can be extracted from aloe vera leaves in any conventional or another suitable manner. Aloe vera has a gelatinous form and enhances thickening (increased viscosity) and emulsifying and stabilizing properties for the emulsifier-stabilizer system. The aloe vera pulp or mucilage is bitter, stiff, spicy, and sweet, and it also blends well with other ingredients. Whether in pulp or mucilage form, water constitutes a major portion (about 98-99% by weight or greater). The rest of the aloe vera composition comprises polysaccharides (acetylated mannan, mannan, acetylated glucomannan, gluco galactomannan, galactan, galactogalacturan, arabinogalactan, pectin, cellulose, glucose, L-rhamnose), anthraquinones (aloin, Aloe-emodin, isobarbaloin anthranol, cinnamic acid ester, aloetic acid), vitamins (thiamine, riboflavin, pyridoxine, Lascorbic acid, β-carotene, choline, folic acid, α-tocopherol), minerals (Ca, Cr, Cu, Fe, Mg, K, P, Na, Zn, Cl), amino acids (glycine, alanine, valine, leucine, isoleucine, proline, hydroxyproline, threonine, methionine, phenylalanine, tyrosine, aspartic acid, glutamic acid, lysine, arginine, histidine), enzymes (catalase, amylase, alkaline phosphatase, lipase, carboxypeptidase, oxidase, cyclooxygenase, superoxide dismutase), arachidonic acid, γ-linolenic acid, steroids, gibberellins, triglycerides, triterpenoid, lignins, salicylic acid, and lecithin. The presence of high amounts of polysaccharides and other compounds renders aloe vera a good emulsifier. The addition of baobab fruit is combined with aloe vera in the emulsifier-stabilizer system at a suitable weight ratio to offset the bitter flavor of aloe vera. For example, the weight ratio of baobab pulp to aloe vera pulp or mucilage can be from 1.5:1 to 2.5:1.

The combination of previously described ingredients (avocado fruit, banana fruit, baobab fruit, flax seed mucilage, and aloe vera pulp or mucilage) used to form the emulsifier-stabilizer system was determined to be very effective in emulsifying and stabilizing food products, such as salad dressing products and ice cream and other frozen dessert products as described herein. The combination of these ingredients yields a system having an HLB score ranging from 8 to 12, a freezing point of about 29° F. to about 30° F. (about −1.67° C. to about −1.11° C.), and a pH ranging from about 4.5 to about 8. However, due to the oxidation of certain compounds in the avocado and banana fruits (phenols converted to quinones) in the emulsifier-stabilizer system which causes a browning color, lemon and/or lime juice can also be added to the mixture of ingredients to prevent or minimize this by inhibiting polyphenol oxidase enzyme activity in the emulsifier-stabilizer system after it is formed.

### Example 2: Plant-Only Frozen Dessert/Ice Cream Food Products

When using the emulsifier-stabilizer system for a plant-only frozen dessert product such as plant-only ice cream, some further plant-only ingredients can be combined with the emulsifier-stabilizer system to enhance properties of the plant-only dessert product such as texture, flavor profile, creaminess, etc.

Additional plant-only ingredients that have been found essential, when combined with the emulsifier-stabilizer system described herein, in forming unique plant-only ice cream or other frozen dessert food products are as follows: plant-only cream (e.g., coconut cream, cashew cream, etc.), plant-only starch (e.g., tapioca starch, potato starch, rice starch, etc.), one or more additional plant-only proteins (e.g., lupin protein), one or more additional types of plant-only fiber (e.g., lupin fiber), one or more additional plant-only oils or fatty acids (e.g., sunflower oil, olive oil, etc.), one or more additional plant-only sugars and/or sugar alternatives (e.g., allulose, custard apple fruit, etc.), and one or plant-only anti-freezing and/or anti-caking agents (e.g., sugar beet). The plant-only food composition may include the emulsifier-stabilizer system and any one or more (e.g., any two or more, any three or more, etc.) of the additional plant-only ingredients as described herein.

For example, additional proteins and fiber solely derived from the plant genus, such as lupin proteins and lupin fiber (derived from lupin beans from the Lupinus subgenus within the plant genus) were determined to enhance the properties of the emulsifier-stabilizer system with regard to plant-only frozen dessert products.

Custard apple fruit can be provided in the emulsifier-stabilizer system to increase the sugars/sweetness of the composition. Custard apple fruit is also beneficial in that it enhances gelling of the system and its stability, due to the pectin content in this fruit. The custard apple fruit also has a creamy texture and a sweet tasting profile. Custard apple fruit can optionally be peeled, and the pulp is then mashed to form a uniform puree or paste when combined with the other ingredients forming the food product.

The major sources of sugar from the essential ingredients are obtained from banana fruit, custard apple fruit, and allulose. Allulose is a sugar replacer as a low calorie sweetening agent, usually obtained in small amounts as it can be found naturally in plant foods such as dried fruits like figs and raisins. It is a ketohexose monosaccharide and it contains 90% fewer calories than sucrose. Sucrose, glucose, and fructose are the soluble sugars present in ripe bananas. Custard apple fruit also has high amounts of total sugars and thus also contributes to the sweetness of the ice cream product. These sugars also positively impact the texture and mouthfeel of the ice cream product.

The plant-only starch, plant-only cream, and plant-only fiber serve as thickening agents in the ice cream product to improve the texture and viscosity of the product. The starch (e.g., tapioca starch) is capable of undergoing gelatinization and the resultant gel is soft, gummy, and chewy. The plant-only cream (e.g., coconut cream) provides not only the fatty acids that mimic dairy-based fats but also functions as a thickener due to its thick and creamy consistency.

The fiber content and polysaccharide fractions in the avocado fruit, plant-only proteins, plant-only fibers, sugar beet, and custard apple fruit can be cryoprotective agents due to their water-binding capacity, gel-forming ability, texturizing, and thickening effects, thus providing anti-freezing properties for the ice cream product. The water binding capacity of the fiber limits the mobility of water molecules from the bulk aqueous phase to the ice crystal surface phase. The addition of fat-rich ingredients (avocado, plant-only cream, 5 sunflower oil) and pectin source (sugar beet) provide anticaking properties as they are responsible for the creamy and smooth texture of ice cream. They reduce the formation of large ice crystals and improve the mouth coating property. Water is also combined with the ingredients to render the emulsifier-stabilizer system as an aqueous-based formulation.

A particularly effective combination of plant-only ingredients, including the ingredients forming the emulsifier-stabilizer system as described herein, are combined in the following amounts (weight percentage ranges) as set forth in Table 2 for use in a plant-only frozen dessert food product:

TABLE 2
Essential ingredients formulation for frozen dessert food product

| | Weight percentage % |
|---|---|
| | (based upon the total weight of the |
| Ingredient | mixture of essential ingredients) |
| Plant-only protein (e.g., lupin | 3.0-3.5 |
| protein) | |
| Plant-only fiber (e.g., lupin fiber) | 1.5-2.0 |
| Plant-only cream (e.g., coconut | 2.0-3.0 |
| cream) | |
| Plant-only starch (e.g., tapioca | 0.1-0.2 |
| starch) | |
| Sunflower oil | 4-5.5 |
| Plant derived sweeteners and/or | 21-27 |
| sugar alternatives | |
| Sugar beet | 2-5 |
| Avocado fruit (pulp) | 0.2-0.5 |
| Banana fruit (pulp) | 0.2-0.5 |
| Flax seed mucilage | 5-10 |
| Custard apple | 2-3 |
| Baobab fruit (pulp) | 0.5-1.0 |
| Emulsifier-stabiliser system (i.e.) | 0.2-0.5 |
| Aloe vera (pulp/mucilage) | |
| Water | 40.0-55.0 |

This unique combination of essential ingredients for a plant-only ice cream (or other frozen desserts) product was determined to provide certain functionalities for the ice cream product as noted in the following Table 3:

TABLE 3
Functionality of the essential ingredients
for the plant-only ice cream food product

| Functionality | Ingredient | Description |
|---|---|---|
| Emulsifier | Avocado fruit, | Conglutinin is the major |
| | flax seed | protein fraction present in |
| | mucilage | plant-only proteins, which act |
| | | as emulsifiers. |
| | | Phospholipids present in |
| | | avocado fruit function as |
| | | emulsifiers |
| | | Flax seed mucilage contains |
| | | polysaccharides and proteins |
| | | which influence the interfacial |
| | | properties in ice cream |
| Stabilizer | Banana fruit, | Presence of soluble fiber in |
| | plant-only | banana fruit, polysaccharides |
| | (lupin) fiber, | in flax seed mucilage, and |
| | flax seed | aloe vera pulp act as |
| | mucilage, | stabilizers in ice cream. |
| | baobab fruit, | |
| | aloe vera | |
| Texturizing/ | Plant-only | The plant-only (lupin) fibers |
| thickening | (lupin) fiber, | exhibit water binding capacity |
| agents | allulose, banana | and oil binding capacity |
| | fruit, avocado | which help improve the |
| | fruit, plant-only | texture. |
| | starch (tapioca | Allulose helps adding bulk |
| | starch), plant- | and improving the mouthfeel |
| | only cream | of ice cream. |
| | (coconut cream) | Banana and avocado fruits |
| | | contain soluble fibers which |
| | | help improve the viscosity of |
| | | the ice cream. |
| | | Gelatinized (tapioca) starch |
| | | imbibes a significant amount |
| | | of water, which helps improve |
| | | the texture of the ice cream |
| | | product. |
| | | Plant-only (coconut) cream |
| | | adds thickening properties to |
| | | the ice cream product. |
| Plant-only fat | Avocado fruit, | Plant-only (coconut) cream |
| sources | sunflower oil, | contains medium chain |
| | plant-only | triglycerides. |
| | cream (coconut | Sunflower oil contains |
| | cream) | approximately 15% saturated, |
| | | 85% unsaturated fatty acid |
| | | and consists of 14-43% oleic |
| | | and 44-75% linoleic acids in |
| | | its unsaturated fatty acid |
| | | content. |
| | | Avocado fruit predominantly |
| | | contains unsaturated fatty |
| | | acids comprising 71% of |
| | | monounsaturated fatty acids |
| | | and 13% polyunsaturated |
| | | fatty acids, and further has |
| | | 16% saturated fatty acids. |
| Sweeteners and | Banana fruit, | Allulose is a monosaccharide |
| sugar | custard apple | and it contains 90% fewer |
| alternatives | fruit, allulose, | calories than sucrose. |
| | etc. | Sucrose, glucose and fructose |
| | | are soluble sugars present in |
| | | banana fruit. |
| | | Custard apple fruit also has |
| | | high amounts of total sugars, |
| | | thus contributing to the |
| | | sweetness of the ice cream |
| | | product. |
| | | These plant-only sugars also |
| | | positively impact the texture |
| | | and mouthfeel of the ice |
| | | cream product. |
| Anti-freezing agents | Avocado fruit, | The soluble fibers/ |
| | plant-only | polysaccharide fractions |
| | (lupin) fiber, | present in these ingredients |
| | sugar beet, | are highly soluble and are |
| | sunflower oil, | potential cryoprotective |
| | custard apple | agents due to their water- |
| | fruit | binding capacity, gel-forming |
| | | ability, texturizing, and |
| | | thickening effects. The water |
| | | binding capacity of the fiber |
| | | limits the mobility of water |
| | | molecules from the bulk |
| | | aqueous phase to the ice |
| | | crystal surface phase of the ice |
| | | cream product. |
| | | Sunflower oil is in linoleic |
| | | acid, which contributes to |
| | | lowering the freezing point of |
| | | the product. |
| Anti-caking agents | Avocado fruit, | The addition of fat-rich |
| | plant-only | ingredients in the avocado |
| | cream (coconut | fruit, plant-only (coconut) |
| | cream), | cream, and the sunflower oil |
| | sunflower oil, | combined with the pectin in |
| | sugar beet | sugar beet act as anticaking |
| | | agents by adding a creamy and |
| | | smooth texture to the ice |
| | | cream product. This |
| | | combination further reduces |
| | | the formation of large ice |
| | | crystals and improves the |
| | | mouth-coating property of ice |
| | | cream product. |

### Example 3: Preparing a Plant-Only Ice Cream Product Including Essential Ingredients

The emulsifier-stabilizer system as well as combination of essential ingredients (as noted in Table 2 herein) can be formed by combining and mixing the ingredients in any suitable manner, any suitable order and any suitable combination(s). In the formation process, preferably the avocado fruit and banana fruit are first soaked (separately or together) in lemon juice and/or lime juice to minimize, prevent and/or delay enzymatic browning of these ingredients and prior to their combination with other ingredients forming the emulsifier-stabilizer system and the food product.

An example embodiment of a method of forming the plant-only frozen ice cream food product with the ingredients as set forth in Table 2 is described as follows. All of the plant derived ingredients are obtained from fresh plant sources.

The avocado and banana fruits are peeled and the avocado fruit is deseeded. Both fruits are mashed into a pulp, paste or puree form and are uniformly mixed and combined in amounts to be at the same or similar weight percentage ratio with each other (e.g., about a 50:50 weight ratio). The combined pulp mixture is immersed in lemon juice and/or lime juice for a suitable period (e.g., about 15 minutes). The pulp is then separated from the lemon and/or lime juice before combination with the other emulsifier-stabilizer system ingredients. The flax seed mucilage and aloe vera pulp/mucilage are prepared in the manner previously described herein. The custard apple fruit and baobab fruit are also peeled and the pulp is mashed to form a puree or paste. These ingredients are then combined with the avocado/banana pulp mixture at ambient/room temperature (about 23° C. to about 30° C.) and mixed in a suitable blender or turbo mixer for a suitable period and at a suitable mixing speed to obtain a uniform mixture of ingredients.

Water and the plant-only protein and plant-only fiber ingredients (e.g., lupin protein and lupin fiber) are combined along with plant-only (e.g., tapioca) starch, plant only (e.g., coconut) cream, sunflower oil, and other plant derived/plant-only sweeteners at ambient/room temperature (about 23° C. to about 30° C.) and mixed in a suitable blender or turbo mixer for a suitable period and at a suitable mixing speed to obtain a uniform mixture of ingredients. This mixture is then pasteurized by continuous mixing for a suitable period of about 10 minutes and at a temperature of about 75° C.

The custard apple fruit and baobab fruit are peeled and their pulps are combined with the flax seed mucilage, and aloe vera pulp and these combined ingredients are then added to the pasteurized mixture. This combination of ingredients is sufficiently mixed to form a uniform mixture. The avocado-banana mixture is then added to this uniform mixture, and the ingredients are then mixed in a suitable blender or turbo mixer for a few minutes or until an overall uniform mixture is achieved.

Any further plant-based ingredients (e.g., further ingredients used to form chocolate or a fruit-based ice cream product) are then added to the uniform mixture, with further mixing and homogenization of the ingredients via blender or turbo mixer. Upon sufficient homogenization of the mixture, the contents were provided in an ice cream machine that churned the mixture while it was being cooled until a temperature of about −8° C. was reached. This also facilitates the aeration of the ice cream product to generate the desired amount of ice crystallization and overrun in the final product. After this mixing, the product was further processed within a blast chiller that blows chilled air to rapidly cool the temperature of the product to about −22° C., thus forming the plant-only ice cream product.

The combination of the emulsifier-stabilizer system with the other essential ingredients, when combined in the manner described herein, facilitates the formation of a plant-only (i.e., 100% plant derived ingredients) ice cream product or any other frozen dessert product that resembles conventional ice cream or other conventional frozen dessert products (i.e., dairy-based ice cream and frozen dessert products) with regard to look, mouth feel, texture, appearance, melting conditions, consistency and, most importantly, taste.

### Example 4: Plant-Only Ice Cream Products Formed with the Essential Ingredients

A wide range of plant-only ice cream products or other plant-only frozen dessert products can be formed with the essential plant-only ingredients as described herein. Two examples of plant-only ice cream products that can be formed include a chocolate-based plant-only ice cream product and a fruit-based plant-only ice cream product. Two examples of plant-only ice cream products are presented in the following Tables 2 and 3, the first being a chocolate plant-only ice cream product and the second being a fruit-based plant-only ice cream product. For the fruit-based product, the additional fruits which provide the flavor for the ice cream product can be some of the same or similar types of fruits as provided in the emulsifier-stabilizer system (e.g., a banana flavored ice cream product) or any one or combinations of different fruits (e.g., strawberry, blueberry, raspberry, cherry, etc.). For each table of ingredients, a 5.5 liter container of ice cream product can be formed.

TABLE 4
Chocolate based plant-only ice cream food product

| | Weight percentage |
|---|---|
| Essential ice cream ingredients | |
| Water | 40-42 |
| Plant-only protein (lupin) | 3-4 |
| Plant-only fiber (lupin) | 1-2 |
| Avocado fruit + Banana fruit | 1-2 |
| Flax seed mucilage | 7-8 |
| plant-only cream (e.g coconut cream) | 1.5-2.5 |
| Custard apple fruit | 2-3 |
| Baobab fruit + Aloe vera pulp | 1-2 |
| Starch (e.g tapioca) | 0.2-0.3 |
| Sunflower Oil | 5-7 |
| Further plant-only ingredients for ice cream | |
| Cacao butter | 0.5-0.6 |
| Cacao paste | 1-2 |
| Cacao powder | 2.7-3.5 |
| Allulose | 22-25 |

TABLE 5
Fruit based plant-only ice cream food product

| | Weight percentage |
|---|---|
| Essential ice cream ingredients | |
| Water | 40-42 |
| Plant-only protein (lupin) | 3-4 |
| Plant-only fiber (lupin) | 1-2 |
| Avocado fruit + Banana fruit | 1-2 |
| Flax seed mucilage | 7-8 |
| Coconut cream | 1.5-2.5 |
| Custard apple fruit | 2-3 |
| Baobab fruit + Aloe vera pulp | 1-2 |
| Tapioca Starch | 0.2-0.3 |
| Sunflower Oil | 4-6 |
| Further plant-only ingredients for ice cream | |
| Fruit(s) | 27-29 |
| Allulose | 16-18 |

The combination of essential ingredients including the emulsifier-stabilizer system is found to work very well in both chocolate-based and fruit-based plant-only ice cream products, thus indicating that this combination of essential ingredients is effective for a wide range of flavors and frozen dessert products. The combination of avocado and banana fruits (rich in lipids, sugars, saponins, and phenolic acids) and flax seed mucilage (rich in polysaccharides, glycoproteins, hexose Sugars, tannins, alkaloids, and steroids) provided a creamy texture with desirable rheological parameters of consistency and viscosity for the ice cream products, as well as a very favorable freezing point for the ice cream products without the requirement for any animal fats, stabilizers, emulsifiers, and anti-freezing additives apart from those that are already provided and 100% based upon plant-only or plant derived ingredients.

The high-fat content of avocado fruit within the emulsifier-stabilizer system with its rich presence of oleic acid (fatty acid) and phospholipid compounds (natural surfactants providing the emulsification properties) helped to mimic/provide similar functionalities as milk fat that are provided in conventional dairy-based ice creams, where the avocado fruit aided in maintaining the whipping ability and homogeneity of the ice cream. Banana fruit pulp, with its firmness and cohesiveness (resulting from the pectin polymer's content), fibrous texture, and good resistance to temperature fluctuations helped create a mix that contained the freezing and melting properties ideal for ice cream. The banana fruit sugars also enhanced the sweet taste of the ice cream product.

Thus, the unique combination of essential ingredients as described herein, which are 100% plant derived or plant-only ingredients to replace the additives and conventional animal ingredients in foods, particularly ice cream and other frozen dessert products, meet the functionalities of animal and dairy-based additives in food products while also providing nutritional benefits for the food products.

Merely for illustration, only representative number/type of graph, chart, block, and sub-block diagrams were shown. Many environments often contain many more block and sub-block diagrams or systems and sub-systems, both in number and type, depending on the purpose for which the environment is designed.

While specific embodiments of the disclosed embodiments have been shown and described in detail to illustrate the inventive principles, it will be understood that the disclosed embodiments may be embodied otherwise without departing from such principles.

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment” and similar language throughout this specification may, but do not necessarily, all refer to the same embodiment.

It should be understood that the figures and/or screen shots illustrated in the attachments highlighting the functionality and advantages of the disclosed embodiments are presented for example purposes only. The disclosed embodiments are sufficiently flexible and configurable, such that it may be utilized in ways other than that shown in the accompanying figures.

It should be understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A plant-only food composition comprising:
a) 3.0-3.5% by weight of a protein, b) 1.5-2.0% by weight of a fiber, c) 2.0-3.0% by weight of a cream, d) 0.1-0.2% by weight of a starch, e) 4-5.5% by weight of a fat, f) 21-27% by weight of a sweetener, g) 2-5% by weight of an anti-freezing agent, and h) 0.2-0.5% by weight of an anti-caking agent, i) 1-10% by weight of an emulsifier-stabilizer system, j) 0.5-1.0% by weight of a thickener, k) 2-3% by weight of a flavoring agent, and l) 40.0-55.0% by weight of water.

2. The food composition of claim 1, wherein the protein is selected from Pea protein, Soy protein, potato protein, chickpea, quinoa, black lentil, peanut, almond, chia seeds, pinto beans, oats, melon seeds or combinations thereof.

3. The food composition of claim 1, wherein the fiber is selected from Corn fiber, black lentil, Citrus fiber, Balangu seed fiber, Psyllium fiber, Quince seed flour, Oat fiber, wheat germ, artichoke fiber, Pea fiber, Chicory root fiber, or combinations thereof.

4. The food composition of claim 1, wherein the cream is selected from Coconut cream, rice cream, cashew cream, sesame seeds cream, cassava cream, oat milk cream, white bean cream, tofu cream, three-leaf yam cream or combinations thereof.

5. The food composition of claim 1, wherein the starch is selected from Tapioca starch, Jackfruit seed starch, Taro starch, Yam starch, Arrowroot starch, Potato starch, Rice starch, Cassava starch, wheat starch, sweet potato starch, wheat starch or combinations thereof.

6. The food composition of claim 1, wherein the fat is selected from Sunflower oil, Olive oil, mango kernel fat, Peanut oil, palm kernel oil, soybean oil, safflower oil, cocoa butter, corn oil, flaxseed oil, sesame oil or combinations thereof.

7. The food composition of claim 1, wherein the sweetener is a plant-derived sugar selected from Allulose (Figs), Banana, Custard apple, Raisins, Durian, Pears, Prunes, Monk fruit, Sapodilla, Agave, Dried apricots, Date palm, Mangosteen, Barhi dates or combinations thereof.

8. The food composition of claim 1, wherein the anti-freezing agent is selected from Oats, Psyllium seed gum, Quince seed gum, Dragon fruit (pulp polysaccharides), Avocado fruit, corn fiber, sugar beet, sunflower oil, custard apple fruit, Chia seed mucilage polysaccharides, tamarillo or combinations thereof.

9. The food composition of claim 1, wherein the anti-caking agent is selected from Sunflower oil, avocado fruit, coconut cream, sugar beet, Dragon fruit (pulp fiber), jackfruit, rice hulls, arrowroot flour, Citrus fiber, potato starch or combinations thereof.

10. The food composition of claim 1, wherein the emulsifier of the emulsifier-stabilizer system is selected from Avocado, flaxseed mucilage, Dragon fruit (Peel), Lentil, Faba bean, Oat bran extract, Durian rind, Liquorice root, Chia seeds mucilage, Pea protein or combinations thereof.

11. The food composition of claim 1, wherein the stabilizer of the emulsifier-stabilizer system is selected from Psyllium seed gum, Okra gum, Gundelia, Basil seed gum, Balangu seed, Banana fruit, corn fiber, flax seed mucilage, baobab fruit, aloe vera or combinations thereof.

12. The food composition of claim 1, wherein the thickener is selected from Quince seed gum, Thale cress, Ipomoea digitata seed, Banana fruit, corn fiber, flax seed mucilage, baobab fruit, aloe vera, Thai hoary basil seed, Kudzu flour, Arrowroot (flour) or combinations thereof.

13. The food composition of claim 1, wherein the flavoring agent is selected from Blackberry, Choco Chips, Choco Almonds, blueberries, raspberries, strawberries, Mango & Passion Fruit, Ginger, custard apple, nutmeg, cinnamon, clove, cardamom, star anise, orange.

14. The food composition of claim 1, wherein the plant-only food composition is a frozen dessert product.

15. A plant-only food composition comprising:
a) 3.0-3.5% by weight of a protein, b) 1.5-2.0% by weight of a fiber, c) 2.0-3.0% by weight of a cream, d) 0.1-0.2% by weight of a starch, e) about 4-5.5% by weight of sunflower oil, f) 21-27% by weight of a sweetener, g) 2-5% by weight of sugar beet, and h) 0.2-0.5% by weight of avocado fruit, i) 0.2-0.5% by weight of banana fruit, j) 5-10% by weight of Flax seed mucilage, k) 2-3% by weight of Custard apple, l) 0.5-1.0% by weight of Baobab fruit, m) 0.2-0.5% by weight of Aloe vera, and n) 40.0-55.0% by weight of water.

16. The food composition of claim 15, wherein the protein is selected from Pea protein, Soy protein, potato protein, chickpea, quinoa, black lentil, peanut, almond, chia seeds, pinto beans, oats, melon seeds or combinations thereof.

17. The food composition of claim 15, wherein the fiber is selected from Corn fiber, black lentil, Citrus fiber, Balangu seed fiber, Psyllium fiber, Quince seed flour, Oat fiber, wheat germ, artichoke fiber, Pea fiber, Chicory root fiber, or combinations thereof.

18. The food composition of claim 15, wherein the cream is selected from Coconut cream, rice cream, cashew cream, sesame seeds cream, cassava cream, oat milk cream, white bean cream, tofu cream, three leaf yam cream or combinations thereof.

19. The food composition of claim 15, wherein the starch is selected from Tapioca starch, Jackfruit seed starch, Taro starch, Yam starch, Arrowroot starch, Potato starch, Rice starch, Cassava starch, wheat starch, sweet potato starch, wheat starch or combinations thereof.

20. The food composition of claim 15, wherein the sweetener is a plant derived sugar selected from Allulose (Figs), Banana, Custard apple, Raisins, Durian, Pears, Prunes, Monk fruit, Sapodilla, Agave, Dried apricots, Date palm, Mangosteen, Barhi dates or combinations thereof.

21. The food composition of claim 15, wherein the avocado fruit, the banana fruit, the baobab fruit, the flaxseed mucilage and the aloe vera form an emulsifier-stabilizer system.

22. The food composition of claim 21, wherein a combination ratio of the avocado fruit and the banana fruit in the emulsifier-stabilizer system comprises a weight ratio from 60:40 to 40:60, preferably a weight ratio of 50:50.

23. The food composition of claim 21, wherein a weight ratio of baobab fruit to aloe vera fruit in the emulsifier-stabilizer system comprises from 1.5:1 to 2.5:1.

24. A method of preparing a plant-only food composition, wherein the method comprises: mixing a) 3.0-3.5% % by weight of a protein, b) 1.5-2.0% by weight of a fiber, c) 2.0-3.0% by weight of a cream, d) 0.1-0.2% by weight of a starch, e) 21-27% by weight of a sweetener, f) 0.5-1.0% by weight of a thickener, and g) 40.0-55.0% by weight of water at 18000-21000 RPM in a blender to obtain a first mixture;
cooking the first mixture at 70-90 degrees Celsius for about 10 to 12 minutes with occasional stirring;
cooling the first mixture to 55-65 degrees Celsius and adding 2-3% by weight of a flavoring agent and blending at 18000-28000 RPM using a blender;
straining using a fine mesh strainer to obtain a second mixture;
adding 1-10% by weight of an emulsifier-stabilizer system, 4-5.5% by weight of a fat, 2-5% by weight of an anti-freezing agent, and 0.2-0.5% by weight of an anti-caking agent to the second mixture and mixing using a high shear homogenizer with a fine slotted stator at 8000-12000 RPM at a pressure of 150-250 Bar for 10-20 minutes to obtain a third mixture;
pasteurizing the third mixture at 68 to 75 degrees Celsius for about 15 to 30 minutes;
cooling and aging the pasteurized third mixture for greater than 4 hours at less than or equal to 5 degrees Celsius to control ice crystallization to obtain a cooled and aged third mixture;
batch freezing of the cooled and aged third mixture between −7 to −3 degrees Celsius for about 6 minutes to achieve an overrun of 12 to 20%;
performing low-temperature freezing and kneading at −8 degrees Celsius to −15 degrees Celsius to obtain the plant-only food composition.

25. The method of claim 24, wherein the method comprises, (i) blast freezing the plant-only food composition at −20 degrees Celsius, (ii) freezing for about 48 to 72 hours; (iii) storing the plant-only food composition at −25 degrees Celsius.

26. The method of claim 24, wherein the protein is selected from Pea protein, Soy protein, potato protein, chickpea, quinoa, black lentil, peanut, almond, chia seeds, pinto beans, oats, melon seeds or combinations thereof.

27. The method of claim 24, wherein the fiber is selected from Corn fiber, black lentil, Citrus fiber, Balangu seed fiber, Psyllium fiber, Quince seed flour, Oat fiber, wheat germ, artichoke fiber, Pea fiber, Chicory root fiber or combinations thereof.

28. The method of claim 24, wherein the cream is selected from Coconut cream, rice cream, cashew cream, sesame seeds cream, cassava cream, oat milk cream, white bean cream, tofu cream, three leaf yam cream or combinations thereof.

29. The method of claim 24, wherein the starch is selected from Tapioca starch, Jackfruit seed starch, Taro starch, Yam starch, Arrowroot starch, Potato starch, Rice starch, Cassava starch, wheat starch, sweet potato starch, wheat starch or combinations thereof.

30. The method of claim 24, wherein the fat is selected from Sunflower oil, Olive oil, mango kernel fat, Peanut oil, palm kernel oil, soybean oil, safflower oil, cocoa butter, corn oil, flaxseed oil, sesame oil or combinations thereof.

31. The method of claim 24, wherein the sweetener is a plant derived sugar selected from Allulose (Figs), Banana, Custard apple, Raisins, Durian, Pears, Prunes, Monk fruit, Sapodilla, Agave, Dried apricots, Date palm, Mangosteen, Barhi dates or combinations thereof.

32. The method of claim 24, wherein the anti-freezing agent is selected from Oats, Psyllium seed gum, Quince seed gum, Dragon fruit (pulp polysaccharides), Avocado fruit, corn fiber, sugar beet, sunflower oil, custard apple fruit, Chia seed mucilage polysaccharides, tamarillo or combinations thereof.

33. The method of claim 24, wherein the anti-caking agent is selected from Sunflower oil, avocado fruit, coconut cream, sugar beet, Dragon fruit (pulp fiber), jackfruit, rice hulls, arrowroot flour, Citrus fiber, potato starch or combinations thereof.

34. The method of claim 24, wherein the emulsifier of the emulsifier-stabilizer system is selected from Avocado, flaxseed mucilage, Dragon fruit (Peel), Lentil, Faba bean, Oat bran extract, Durian rind, Liquorice root, Chia seeds mucilage, Pea protein or combinations thereof.

35. The method of claim 24, wherein the stabilizer of the emulsifier-stabilizer system is selected from Psyllium seed gum, Okra gum, Gundelia, Basil seed gum, Balangu seed, Banana fruit, corn fiber, flax seed mucilage, baobab fruit, aloe vera or combinations thereof.

36. The method of claim 24, wherein the thickener is selected from Quince seed gum, Thale cress, Ipomoea digitata seed, Banana fruit, corn fiber, flax seed mucilage, baobab fruit, aloe vera, Thai hoary basil seed, Kudzu flour, Arrowroot (flour) or combinations thereof.

37. The method of claim 24, wherein the flavoring agent is selected from Blackberry, Choco Chips, Choco Almonds, blueberries, raspberries, strawberries, Mango & Passion Fruit, Ginger-custard apple, nutmeg, cinnamon, clove, cardamom, star anise, orange.

38. The method of claim 24, wherein physical characterization data associated with the ingredients of the plant-only food composition comprising the protein, fiber, cream, starch, sweetener, thickener, emulsifier, stabilizer, fat, anti-freezing agent, anti-caking agent is stored in a database, wherein a machine learning model determines a unique combination of ingredients based on the physical characterization data to prepare the plant-only food composition.

39. The method of claim 38, wherein the physical characterization data of the ingredients comprise functional properties that comprise emulsification properties, stabilization properties, gelling properties, fat-replacement properties, Ayurvedic and/or other holistic properties, physicochemical properties that comprise pH, viscosity, moisture content, density, mechanical properties that comprise adhesive strength, tensile strength, shear resistance, chemical and/or molecular descriptor properties that comprise bio-active/bioavailability properties, molecular structure, phytonutrient properties, sensorial properties that comprise taste, smell, color, texture, mouth feel, and nutritional information that comprises macronutrient/micronutrient properties.

40. The method of claim 24, wherein the plant-only food composition is a frozen dessert product.
